(19) United States
(12) Patent Application Publication
(10) Pub. No.: US 2009/0289578 A1
(43) Pub. Date: Nov. 26, 2009

(54) PARALLEL TYPE SINGLE-WIRE ADDRESSABLE LIGHTING DEVICE

(76) Inventor: Wen-Chi PENG, Jhonghe City (TW)

Correspondence Address: HDLS Patent & Trademark Services, P.O. BOX 220746, CHANTILLY, VA, 20153-0746, US

(21) Appl. No.: 12/465,257

(22) Filed: May 13, 2009

(30) Foreign Application Priority Data
May 23, 2008 (TW) 097119188
Apr. 23, 2009 (TW) 098113455

(51) Int. Cl. H05B 37/02

(52) U.S. Cl. 315/294

(57) ABSTRACT

A parallel type single-wire addressable light device includes a microprocessor, at least one lighting module and at least one signal amplifier. The microprocessor includes an address transmission line and a data transmission line. The plurality of lighting modules is composed of a control driver and at least one lamp set, and the control driver is connected in parallel to the microprocessor through the address transmission line and the data transmission line. The signal amplifier is electrically connected between the microprocessor and the control driver. The address transmission line of the microprocessor transmits an address define signal to set the address of each lighting module, and then the data transmission line outputs data to control any one or any two or more lighting modules for controlling a change of light.

### BACKGROUND OF THE INVENTION

1. Field of the Invention

The present invention relates to a light emitting diode (LED) cluster lamp module, and more particularly to a parallel type single-wire addressable light device.

2. Description of Prior Art

At present, LED cluster lamp modules are mainly divided into a serial type connection and a parallel type connection, and these two types of LED cluster lamp modules are used extensively for stylish building appearances, trees, businesses signs and landscapes to improve an aesthetic look of things.

In a traditional serial type LED cluster lamp module, a plurality of LED cluster lamp modules are connected in series with one another, and the quantity of serially connected LED cluster lamp modules depends on the size of a wound object, and a controller of the first LED cluster lamp module of the serially connected modules is provided for controlling an LED lamp set of all LED cluster lamp modules. Although such serial connection can connect the LED cluster lamp modules easily, yet control signals cannot be transmitted if any one of the LED cluster lamp modules fails, and the failed LED cluster lamp module and all other LED cluster lamp modules behind the failed LED cluster lamp module will be unable to receive the control signals or these LED cluster lamp modules will not be lit.

In addition, the parallel type LED cluster lamp module connects a plurality of LED cluster lamp modules to the controller in parallel, and each LED cluster lamp module requires a control line and an address line for the control. If ten LED cluster lamp modules are connected in parallel, then the controller requires ten control lines and ten address lines to control the ten LED cluster lamp modules. If this type of parallel type LED cluster lamp modules is used and any one of the LED cluster lamp modules fails, then the control of other LED cluster lamp modules will not be affected. However, the larger the quantity of parallel LED cluster lamp modules, the larger is the quantity of the control lines and the address lines. Therefore, the circuit becomes complicated and uneasy to manufacture and also incurs a high cost.

### SUMMARY OF THE INVENTION

In view of the aforementioned shortcomings of the parallel connection of the conventional LED cluster lamp modules, the inventor of the present invention redesigns the parallel type connection and uses a single-wire addressing method to control a plurality of parallel LED lamp sets to simplify the circuit, make the manufacture easy, and lower the cost.

To achieve the foregoing objective, the present invention provides a parallel type single-wire addressable light device, comprising: a microprocessor, at least one lighting module and at least one signal amplifier. The microprocessor includes an address transmission line and a data transmission line. The lighting module comprises a control driver and at least one lamp set. The control driver is electrically coupled to the microprocessor through the address transmission line and the data transmission line, and the control driver includes: a counter, an encoder, an address input register, a comparator, an address register, a decoder, a data shift register, a latch circuit and a sensing detector. The lamp set comprises a red LED, a green LED, a blue LED, and a white LED, and the lamp set is electrically connected to a latch circuit of the control driver. The signal amplifier is electrically connected to the data transmission line between the microprocessor and the control driver to avoid signal attenuation during signal transmissions.

### BRIEF DESCRIPTION OF DRAWINGS

FIG. 1 is a schematic circuit diagram of a parallel type single-wire addressable light device of the present invention;

FIG. 2 is an internal schematic circuit diagram of a control driver of the present invention;

FIGS. 3(a) and 3(b) are schematic views of two kinds of power on timing signals of the present invention;

FIG. 3(c) is a schematic view of a reset timing signal at a power on initial state of the present invention;

FIG. 3(d) is a schematic view of an address define mode timing signal of a lighting module in accordance with the present invention;

FIG. 3(e) is a schematic view of a normal mode control timing signal of a lighting module in accordance with the present invention;

FIG. 3(f) is a schematic view of a test mode timing signal of a lighting module in accordance with the present invention;

FIG. 3(g) is a schematic view of an address redefine mode test of a lighting module in accordance with the present invention;

FIG. 4 is a schematic view of another preferred embodiment of the present invention;

FIG. 5 is a schematic view of a further preferred embodiment of the present invention; and

FIG. 6 is a schematic view of another further preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

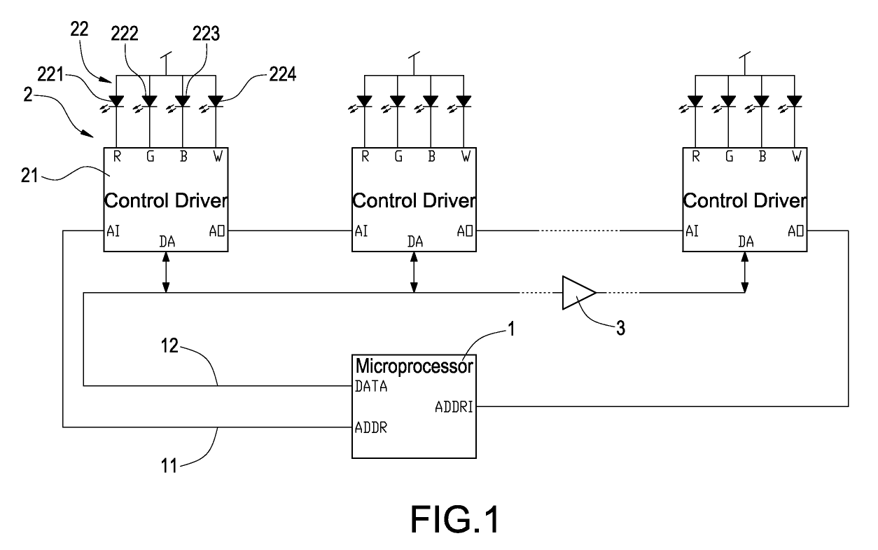

With reference to FIG. 1 for a schematic circuit diagram of a parallel type single-wire addressable light device of the present invention, the parallel type single-wire addressable light device comprises: a microprocessor 1, at least one lighting module 2 and at least one signal amplifier 3.

The microprocessor 1 includes an address transmission line 11 and a data transmission line 12.

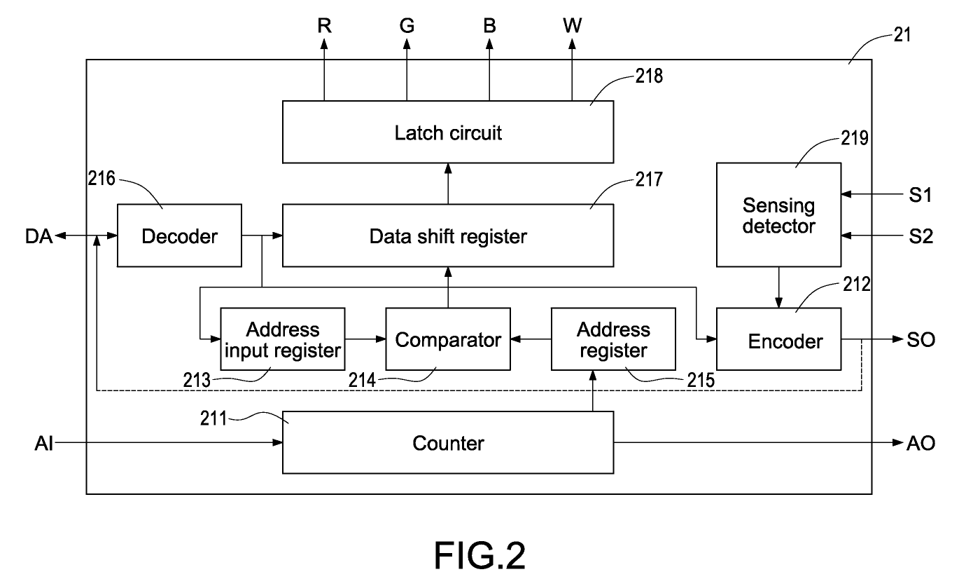

The lighting module 2 is comprised of a control driver 21 and at least one lamp set 22. The control driver 21 is electrically coupled to the microprocessor 1 through the address transmission line 11 and the data transmission line 12. The control driver 21 includes a counter 211, an encoder 212, an address input register 213, a comparator 214, an address register 215, a decoder 216, a data shift register 217, a latch circuit 218 and a sensing detector 219 (as shown in FIG. 2). The lamp set 22 is comprised of a red LED 221, a green LED 222, a blue LED 223 and a white LED 224, and electrically coupled to the latch circuit 218 of the control driver 21.

The signal amplifier 3 is electrically connected to the data transmission line 12 between the microprocessor 1 and the control driver 21 for avoiding signal attenuation during the transmission process.

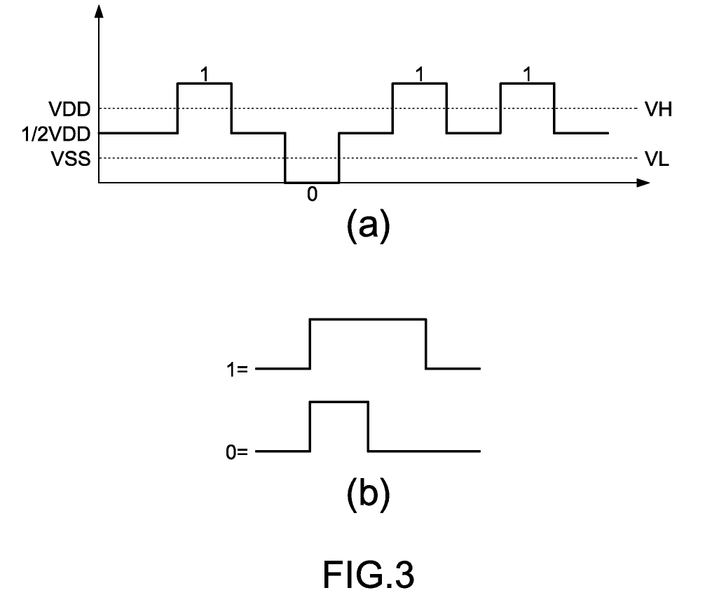

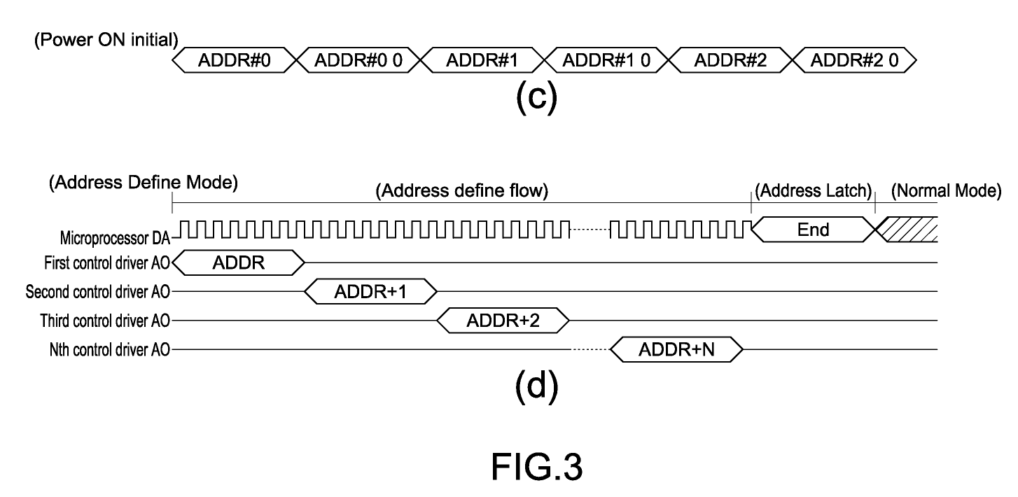

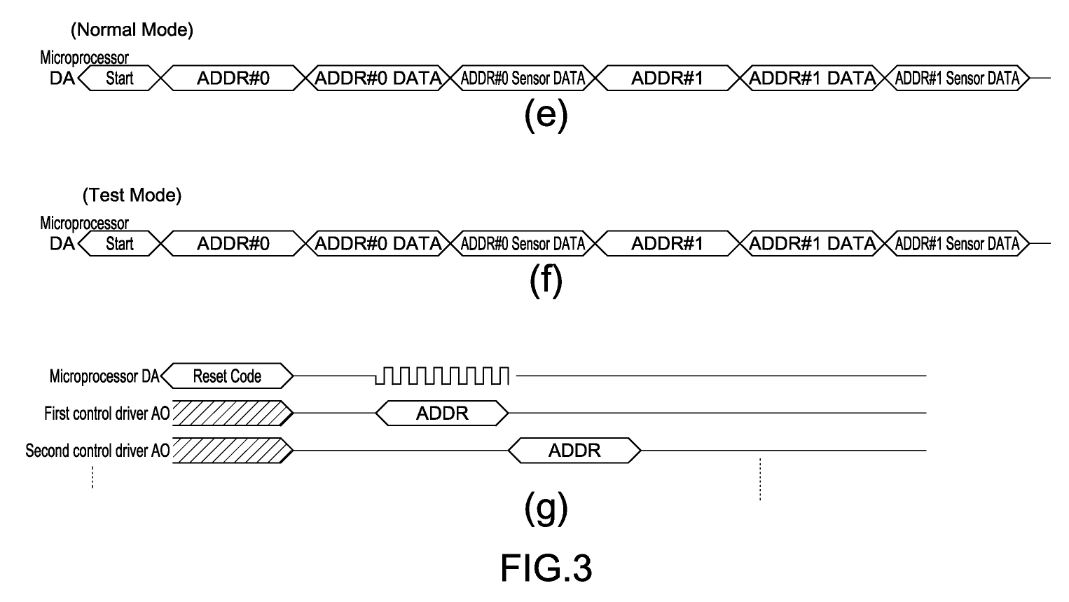

The data format of the present invention includes three types of signal transmissions, respectively: data timing, power on timing, and retrieval. Two of these signal transmission are described here. In a method of applying a voltage level to a clock as shown in FIG. 3(a), the data transmission line 12 is situated at a state of transmitting no data and represented by a voltage level of ½ VDD, before the microprocessor 1 starts transmitting data. When the microprocessor 1 starts transmitting data, a digital signal “1” or “0” represents a datum of an instruction executed by each LED of the lamp set 22, and the action corresponding to the execution can be defined in advance. In the data transmitting process, each bit “1” or “0” is returned to the voltage level of ½ VDD when the process ends, and the next bit is transmitted, and thus data and clock are included.

In another data transmission as shown in FIG. 3(b), the data in the form of digits “0” and “1” is used for transmitting data timing and power on timing signals in a predetermined time interval. Similarly, a signal can be defined as staying at VDD or VSS if no data is transmitted within a general time period. After a certain period of time, it indicates a latch instruction and shows a change, and thus a signal line can be used for achieving the effects of transmitting data timing, power on timing and simultaneous display signals. The major difference between the two resides on that the former is a static way of identifying data, and the latter requires LED of each lamp set 22 to generate timing to identify data.

When a lighting device is at a power on initial state, the microprocessor 1 outputs a signal (as shown in the reset timing signal in FIG. 3(c)) to clear an address register 215 in each control driver 21 to zero.

After each control driver 21 is reset, the microprocessor 1 transmits an address define signal (as shown in the address define mode timing signal in FIG. 3(d)) from the address transmission line 11. After the address define signal is inputted at an input end (AI) of the counter 211 of the first control driver 21, the counter 211 stores the address define signal into the address register 215, and sets an identification code (ID) of the first control driver 21 to “0”. After the identification code (ID) of the first control driver 21 is set, an output end (AO) of the counter 211 transmits the address define signal to a counter 211 of a second control driver 21. Now, the counter 211 is incremented by 1 automatically, and the address incremented by 1 is stored into the address register 215 and the identification code (ID) of the second control driver 21 is set to “1”, and so on and so forth to complete defining the addresses of all control drivers 21 and then return the signals into the microprocessor 1, so that the microprocessor 1 can know the number of lighting modules required to be controlled.

After the address of each control driver 21 is defined, a series of data control signals are transmitted from the data transmission line 12 of the processor 1, and the data control signal includes an identification code (ID) and a datum for controlling the lamp set 22 to produce a change (as shown in the normal mode timing signal in FIG. 3 (e)). After the data control signal is inputted from a decoder 216 of the control driver 21, the decoder 216 transmits the identification code (ID) included in the data control signal to an address input register 213, and a comparator 214 compares the identification code (ID) with the address originally stored in the address register 215. If the compared identification code (ID) is different, the data following the identification code (ID) for controlling a change of the lamp set 22 cannot be transmitted from the decoder 216 to the data shift register 217, and thus the lamp set 22 cannot be controlled to produce any change. If the compared addresses are the same, the data following the identification code (ID) for controlling a change of lamp set 22 is transmitted from the decoder 216 into the data shift register 217, and then the latch circuit 218 controls the lamp set 22 to produce several lit, not lit, blink, irregular or irregular changes in different time periods or in a same time period.

If the lighting device fails, the microprocessor 1 transmits data signals sequentially into each control driver 21 through the data transmission line 12, and the microprocessor 1 has not received a signal returned from any one of the control drivers 21, then the microprocessor 1 will know exactly which lighting module 2 fails (as shown in the test mode timing signal in FIG. 3(f)), so that a user can replace a new lighting module 2 or repair the failed lighting module 2.

After the lighting device is inspected, the microprocessor 1 sets the addresses for all lighting modules 2 (as shown in the address define mode of FIG. 3(g)).

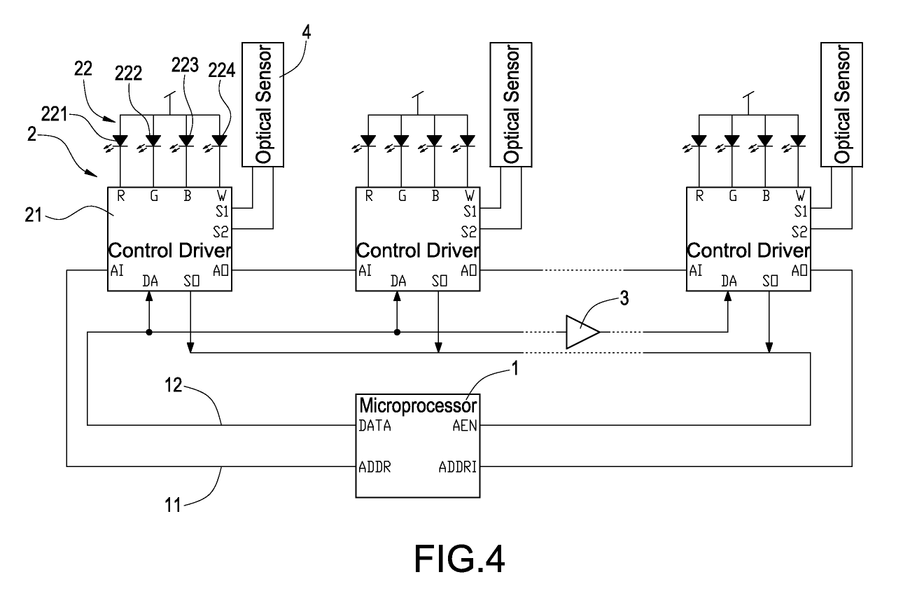

With reference to FIG. 4 for a schematic view of another preferred embodiment of the present invention, the lamp set 22 of this preferred embodiment includes an optical sensor 4 installed adjacent to the lamp set 22 and electrically connected to input ends S1, S2 (as shown in FIG. 2) of the sensing detector 219 in the control driver 21. The optical sensor 4 is provided for detecting the brightness of each LED of the lamp set 22 and then transmitting the signal to the sensing detector 219 for processing, and the encoder 212 decodes the signal, and the signal is returned from an output end SO to the microprocessor 1, and an input end AEN of the microprocessor 1 determines if the brightness of the LED of the lamp set 22 attenuates, and then a series of data control signals will be transmitted through the data transmission line 12 of the microprocessor 1 next time. The data control signal includes an identification code (ID) and a datum for controlling a change of the lamp set 22 as well as adjusting the brightness of the LED (as shown by the normal mode timing signal in FIG. 3(e)).

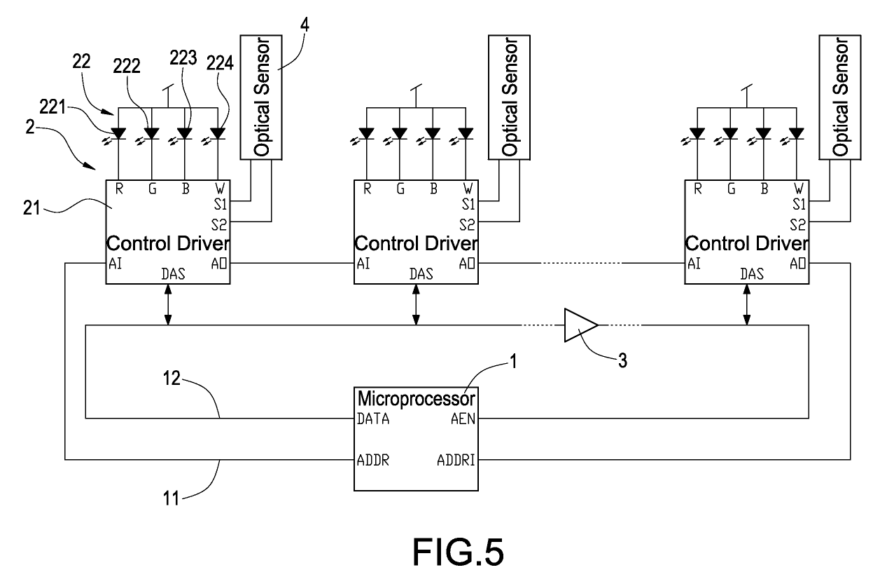

With reference to FIG. 5 for a schematic view of a further preferred embodiment of the present invention, the lamp set 22 of this preferred embodiment includes an optical sensor 4 installed adjacent to the lamp set 22 and electrically connected to the sensing detector 219 (as shown in FIG. 2) in the control driver 21. The optical sensor 4 is provided for detecting the brightness of each LED of the lamp set 22 and transmitting the signal to the sensing detector 219 for processing, and then the encoder 212 encodes and returns the signal to an input/output end (DA) of the decoder 216 (as indicated by the dotted line in FIG. 2), and then to the microprocessor 1 for processing to adjust the brightness of the LED. Therefore, the design of the control driver 21 electrically connected to the microprocessor 1 can save a transmission line.

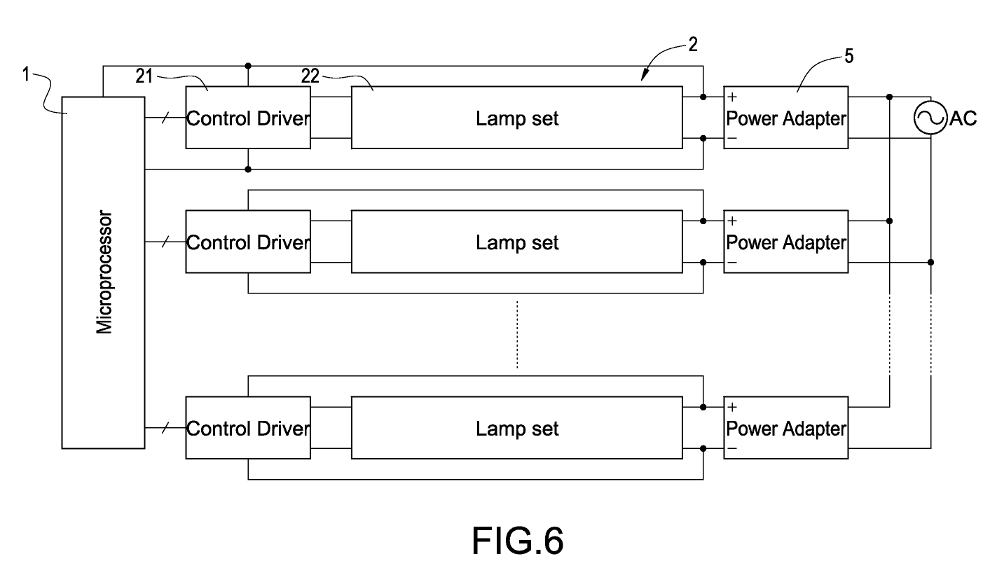

With reference to FIG. 6 for a schematic view of another further preferred embodiment of the present invention, a microprocessor 1 is connected in parallel with a plurality of lighting modules 2, and a power adapter 5 is electrically connected to each lighting module 2 for converting AC into DC and supplying the required DC power to the lamp sets 22.

In summation of the description above, the invention can achieve the expected objectives and overcome the shortcomings of the prior art. The invention also complies with the requirements of patent application and is thus duly filed for patent application. While the invention has been described by means of specific embodiments, numerous modifications and variations could be made thereto by those skilled in the art without departing from the scope and spirit of the invention set forth in the claims.

What is claimed is:

1. A parallel type single-wire addressable light device, comprising:
a microprocessor, including an address transmission line and a data transmission line, for outputting an address define signal and a data control signal;
a plurality of lighting modules, each comprising a control driver and at least one lamp set electrically coupled to the control driver, and the control driver being connected to the microprocessor in parallel through the address transmission line and the data transmission line;
wherein, the address transmission line of the microprocessor sets an address of each lighting module by transmitting the address define signal, and the data transmission line outputs data to control any one or any two or more lighting modules for controlling a change of light.

2. The parallel type single-wire addressable light device of claim 1, wherein the data transmission line sends out a series of data control signals, and the data control signal includes an identification code (ID) and a datum generated by the control lamp set.

3. The parallel type single-wire addressable light device of claim 1, wherein the lamp set includes an optical sensor disposed adjacent to the lamp set and electrically coupled to the control driver.

4. The parallel type single-wire addressable light device of claim 1, wherein the lamp set includes an optical sensor disposed adjacent to the lamp set and electrically coupled to the control driver, for detecting brightness of the lamp set, and outputting a series of data control signals through the data transmission line of the microprocessor, and the data control signal includes an identification code (ID), and data for controlling the change of the lamp set and adjusting the brightness of the lamp set.

5. The parallel type single-wire addressable light device of claim 1, wherein the control driver comprises:
a counter, electrically coupled to the microprocessor and a next counter, for incrementing the address define signal for each time;
a decoder, electrically coupled to the microprocessor, for decoding a signal transmitted from the microprocessor;
an address input register, electrically coupled to the decoder, for buffering an identification code (ID) transmitted from the microprocessor;
an address register, electrically coupled to the counter, for storing a cumulative value of the counter;
a comparator, electrically coupled to the address input register and the address register, for comparing the identification codes (ID) of the two registers; and
a data shift register, electrically coupled to the comparator and decoder, for receiving a data decoded by the decoder to control a change of the lamp sets.

6. The parallel type single-wire addressable light device of claim 5, wherein the control driver further comprises a latch circuit electrically coupled between the lamp set and the data shift register.

7. The parallel type single-wire addressable light device of claim 5, wherein the control driver further comprises an encoder electrically coupled to the decoder, and the encoder is electrically coupled to a sensing detector, and the sensing detector is electrically coupled to an external optical sensor for detecting brightness of the lamp set sensed by the external optical sensor, and the brightness is transmitted to a microprocessor after an encoding by the encoder takes place.

8. The parallel type single-wire addressable light device of claim 7, wherein the sensing detector is electrically coupled to the external optical sensor, for externally sensing and detecting the brightness of the lamp set sensed by the optical sensor, and then transmitting the brightness to an input/output end of the decoder after the encoding by the encoder takes place, and then transmitting the encoded brightness to the external microprocessor.

9. The parallel type single-wire addressable light device of claim 1, wherein the lamp set is comprised of a red LED, a green LED, a blue LED and a white LED.

10. The parallel type single-wire addressable light device of claim 1, further comprising a plurality of power adapters electrically coupled to each lighting module.

11. The parallel type single-wire addressable light device of claim 1, further comprising at least one signal amplifier electrically coupled to the data transmission line.
